(19) United States
(12) Patent Application Publication
(10) Pub. No.: US 2009/0290854 A1
(43) Pub. Date: Nov. 26, 2009

(54) Method of Asynchronous Image and Audio Recording

(75) Inventors: Michael Anthony Smith, Mountain View, CA (US); David Kazumi Hanabusa, Palo Alto, CA (US)

Correspondence Address: Stevens Law Group, 1754 Technology Drive, Suite #226, San Jose, CA, 95110, US

(73) Assignee: Piklips LLC, Palo Alto, CA (US)

(21) Appl. No.: 12/244,388

(22) Filed: Oct. 2, 2008

Related U.S. Application Data
(60) Provisional application No. 61/055,914, filed on May 23, 2008.

(51) Int. Cl. H04N 5/91

(52) U.S. Cl. 386/96; 386/E05.003

(57) ABSTRACT

A method configured according to the invention receives a user input. Then a recording of an audio file and a corresponding audio timer are initiated. When the audio timer times out, the recording of the audio file is ended, and an image file is captured. In an embodiment of the invention, the audio recording is ended and the image file is captured if the audio timer times out prior to receiving a second user input. In an embodiment of the invention, if the audio timer does not time out prior to receiving a second user input, an image file is captured. In an embodiment of the invention, if the audio timer does not time out prior to receiving a third user input, then the recording of the audio file is ended.

### RELATED APPLICATIONS

This application claims priority based on U.S. Provisional Patent Application No. 61/055,914, filed on May 23, 2008, entitled “Method of Asynchronous Image and Audio Recording.”

### BACKGROUND OF THE INVENTION

For years, people have captured photographs with cameras, recorded audio with tape recorders, and performed both simultaneously in the form of video/audio recording with camcorders. The evolution of digital electronics has resulted in devices that can perform any of these three tasks. Today, some digital cameras can also record audio or capture full-motion video/audio. Other devices such as Personal Digital Assistants (PDAs) and cell phones may also include cameras and/or recorders to do the same. Camcorders often can also take pictures like a camera.

However, cameras, audio recorders, and camcorders do not allow the independent recording of audio before, during, or after the acquisition of an image so that it may be coordinated with the image for later editing, cataloging, or communicating.

For example, using a camcorder's audio/video recording function forces the user to record audio only during the recording of images and usually forces the recording of multiple, lower quality images instead of a single high quality image. Using the camera function and audio recording function requires the user to independently and manually perform multiple actions on the device and coordinate their content. The problem may be alleviated by addressing these inefficient manual processes without compromising quality or limiting the flexibility of staging the audio/image acquisitions.

Every day, hundreds of millions of images are created on digital camera devices that do not have an easy means for recording metadata of, or orthogonal descriptive information regarding the content of, the image. Thus, current means of creating metadata for each image requires additional manual effort by the user that may distract from the user's focus on the image content.

Users of cameras may wish to annotate metadata about image content prior to the capture of such an image. Current manual methods require that this metadata, acquired after image acquisition, to be automatically associated, or that the user must manually catalog the metadata before acquiring the image. This manual process takes additional time and effort and may force the user to lose other image acquisition opportunities or lose metadata.

For current devices that provide textual or audio recording of such information, multiple manual efforts are required both before and after image acquisition to record the metadata and properly associate it with the image. This delay may prevent the capture of the needed or desired image by the user who is too busy recording metadata.

Using a camcorder function that permits the recording of audio, which could be used as metadata, synchronously with video images results in lower resolution images that often do not collect the detail of a still image. Most video recorders capture images at one-tenth to one-hundredth the resolution of a digital camera. For example, resolutions range from 320×160 pixels of 4-bit/color to 1920×1080 pixels with 8-bit/color for video recorders, verses 6000×4000 pixels with 12-bit/color in a professional digital SLR camera. It may also be desirable for a user to extract a still image from the video, but this would require an additional, and sometimes time-consuming, effort on the part of the user. In addition, camcorders only permit the recording of audio during the video recording, which may not be appropriate for metadata capture due to ambient noise during image acquisition.

Hence, it is desirable to have a solution, without the above-described disadvantages. As will be seen, the invention provides such a solution in an elegant manner.

### BRIEF DESCRIPTION OF THE DRAWINGS

In order that the advantages of the invention will be readily understood, a more particular description of the invention briefly described above will be rendered by reference to specific examples illustrated in the appended drawings. Understanding that these drawings depict only typical examples of the invention and are not therefore to be considered limiting of its scope, the invention will be described and explained with additional specificity and detail through use of the accompanying drawings, in which:

FIG. 1 illustrates an embodiment of the invention as contrasted with the prior art.

FIG. 2 illustrates a process timeline for an embodiment of the invention.

FIGS. 3A-B illustrate an embodiment of the invention.

FIG. 4 illustrates a flowchart of an embodiment of the invention.

FIG. 5 illustrates a flowchart of another embodiment of the invention.

FIGS. 6A-C illustrate flowcharts of another embodiment of the invention.

### DETAILED DESCRIPTION OF THE INVENTION

The invention has been developed in response to the present state of the art, and in particular, in response to the problems and needs in the art that have not yet been fully solved by currently available encoding/decoding architectures. Accordingly, the invention has been developed to provide novel apparatus and methods for automatically recording audio in conjunction with capturing an image. The features and advantages of the invention will become more fully apparent from the following description and appended claims and their equivalents, and also any subsequent claims or amendments presented, or may be learned by practice of the invention as set forth hereinafter.

Consistent with the forgoing, disclosed herein is a method for automating the recording of audio in conjunction with the capture of an image. Such a manner of data acquisition may be useful for the purpose of organizing the audio and image together in a correlated way, and may allow the user a means for performing either the image capture or audio recording first and asynchronously to the other. By automating both image acquisition and audio recording as one user action, but with the flexibility of allowing both to occur in different time frames, the user is freed from having to draw attention away from the subjects being photographed and/or recorded.

The invention thus includes a methodology for facilitating image capture, such as that performed with a digital camera, and audio recording, such as that performed with a digital audio recorder, and to perform both operations in concert but without the synchronization of one or more images with the associated recording as required with video/audio camcorder. This method allows for an audio message recording to precede, coincide, or follow an image capture. In effect, as a result, the audio may act as the metadata for the image, or the image can act as the metadata for the audio recording.

A method configured according to the invention receives a user input. Then a recording of an audio file and a corresponding audio timer are initiated. When the audio timer times out, the recording of the audio file is ended, and an image file is captured.

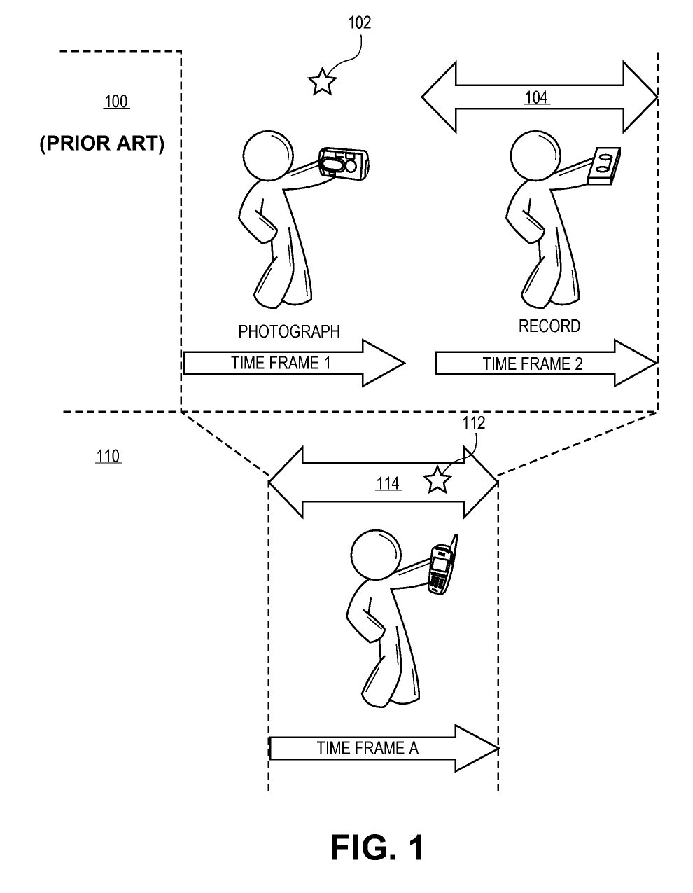

As illustrated in FIG. 1, in the case 100 of the prior art devices, the photographing of a still image and recording of audio require two separate instances of action performed by the user, at Timeframes 1 and 2, respectively. This is the case even though the photography takes place at an instance 102, and the audio recording takes place through an interval 104. Thus, instance 102 falls outside of interval 104. By contrast, the invention as shown at 110 allows a user to record and photograph in a streamlined manner throughout Timeframe A. The audio recording may take place through interval 114, while the still image capture may take place during an instance 112 within interval 114.

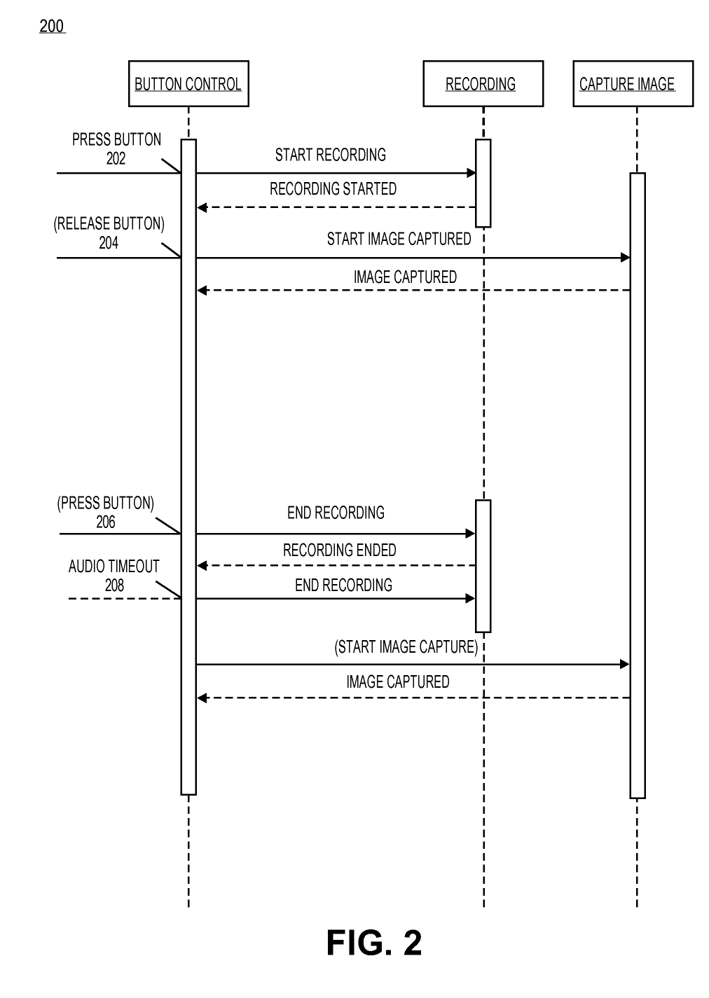

FIG. 2 illustrates a timeline 200 showing an example of an embodiment of the process of the invention. A user input may be received by, for example, a user pressing a button on a device at 202. This prompts the device to begin audio recording. Should the user release the button at 204, prior to the preset audio timeout at 208, an image may then be captured. Then, should the user press the button again at 206, again prior to the preset audio timeout at 208, this may indicate to the device a signal that the audio recording should be ended prior to the preset timeout.

However, if the button is not pressed again at 206, then the recording may then be ended at the preset audio timeout of 208. In addition, if the button was never released at 204 prior to the audio timeout of 208, the timeout at 208 may trigger the device to not only end the audio recording, but also capture an image.

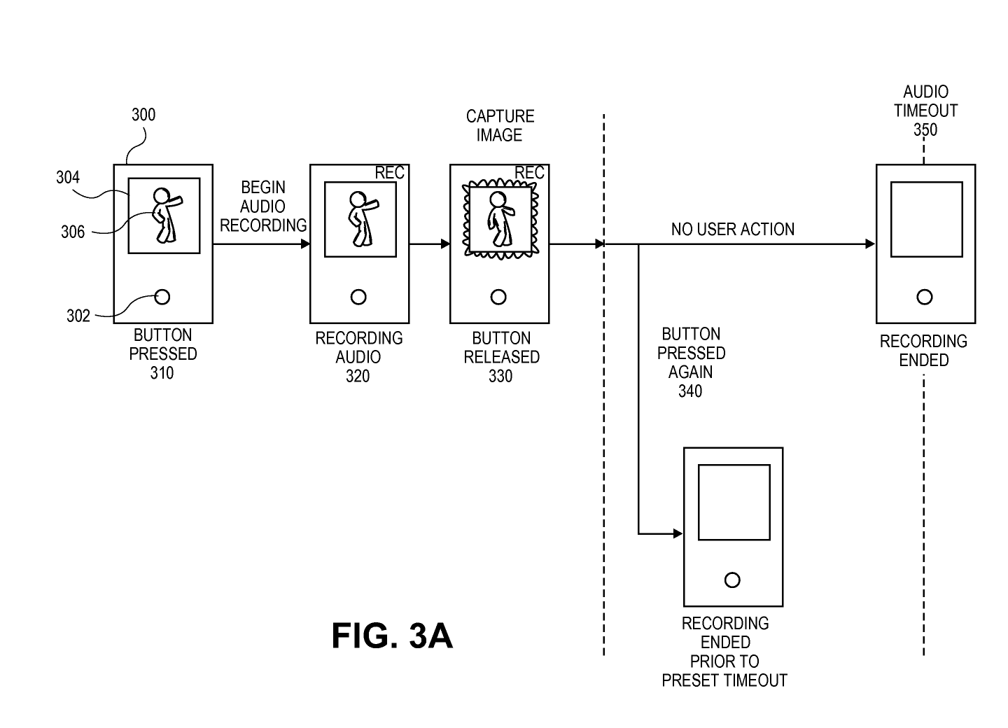

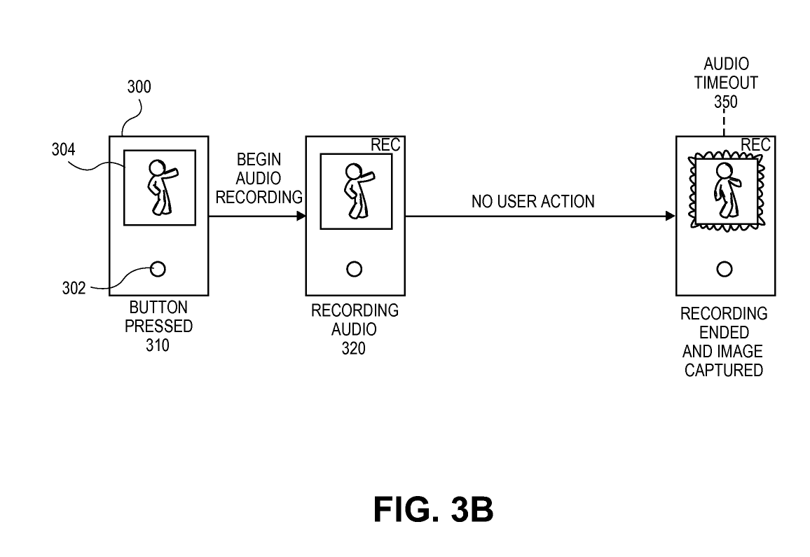

As a pictorial example, FIGS. 3A-B show this process as embodied in a device 300. Device 300 may be any device that has digital image capture and audio recording, such as but not limited to a digital camera, personal digital assistant (PDA), video camera (camcorder), or mobile phone. The process may be initialized via various methods. For example, initialization may be performed through a system menu selection of a specially selected “hot button” such as the Microsoft Windows Mobile camera button, so as to load the application and set it into its initial state. This method is applicable to all systems that support software/firmware enhancement, including but not limited to Microsoft Windows (all versions), Symbian, Palm OS, RIM's Blackberry, Unix and its variants such as Linux, Solaris, and Apple OS (including iPhone OS).

As shown in FIG. 3A, device 300 may include, for example, a button 302 and a display 304. Once the button 302 is initialized for the described method, display 304 may show a camera preview 306 of the scene sensed by a camera of the device 300 in real time. Once the button 302 is pressed at 310, audio recording may be signaled to begin. Audio is then recorded at 320, until further action, such as but not limited to the user releasing button 302 at 330. This button release may signal device 300 to capture the image being currently previewed by the camera of device 300. If no further user action is received by device 300, recording may be signaled to end at a preset audio timeout 350. However, should the device 300 receive another input, such as but not limited to another press of button 302 at 340, prior to the preset audio timeout 350, the recording may be ended at 340.

Another scenario is illustrated in FIG. 3B. In this case, after the initial button press at 310, no user input is received by device 300 prior to the preset audio timeout at 350. The method may be configured so that once the audio timeout occurs at 350, the audio recording is ended and the image is also captured.

The method shown in FIGS. 3A-B enables a foolproof, user-friendly way to ensure that the image will be captured. Regardless of whether the user releases the button after initially pressing it, or holds the button down through the preset audio recording time, an image capture will not be missed. This may be helpful in various situations, especially those in which the user prefers to focus on observing his environment, as opposed to recording it. For example, the user may be in a car driving by a building of interest. The disclosed method allows the user to photograph the building while recording his own audible reading of nearby street signs so as to enable later locating the building. As another example, a user may wish to capture an image of an intruder while recording the sound of the door being pried. The disclosed method may also be useful in social situations, where a user may find it helpful to record a new friend telling his name to the user, while capturing a photo of the new acquaintance. Another example, among many other possibilities, is that of logging oral notes while photographing a crime scene.

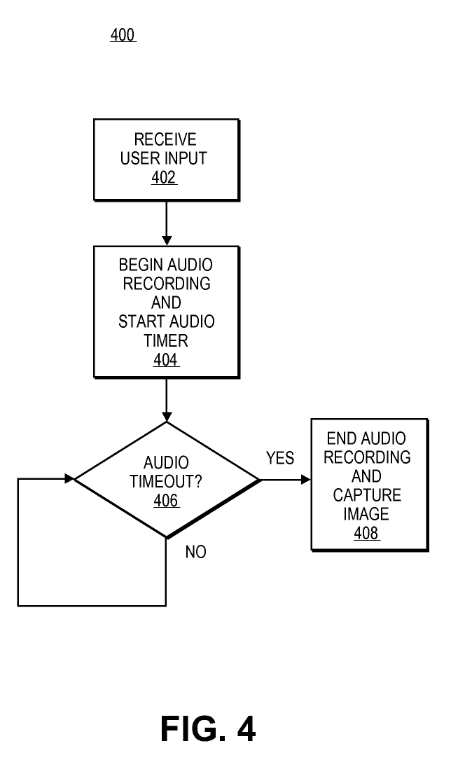

Flowchart 400 of FIG. 4 illustrates another embodiment of the invention. At step 401, a user input is received. At step 404, audio recording begins and a corresponding audio timer is started. As long as the audio timer does not time out at 406, audio recording continues. Once the audio timer times out, the audio recording is ended, and an image is captured at step 408. This is a simplified version of the above embodiments of the invention, described in reference to FIGS. 2-3. This version also ensures that an image is captured, regardless of user action or non-action subsequent to the initial user input.

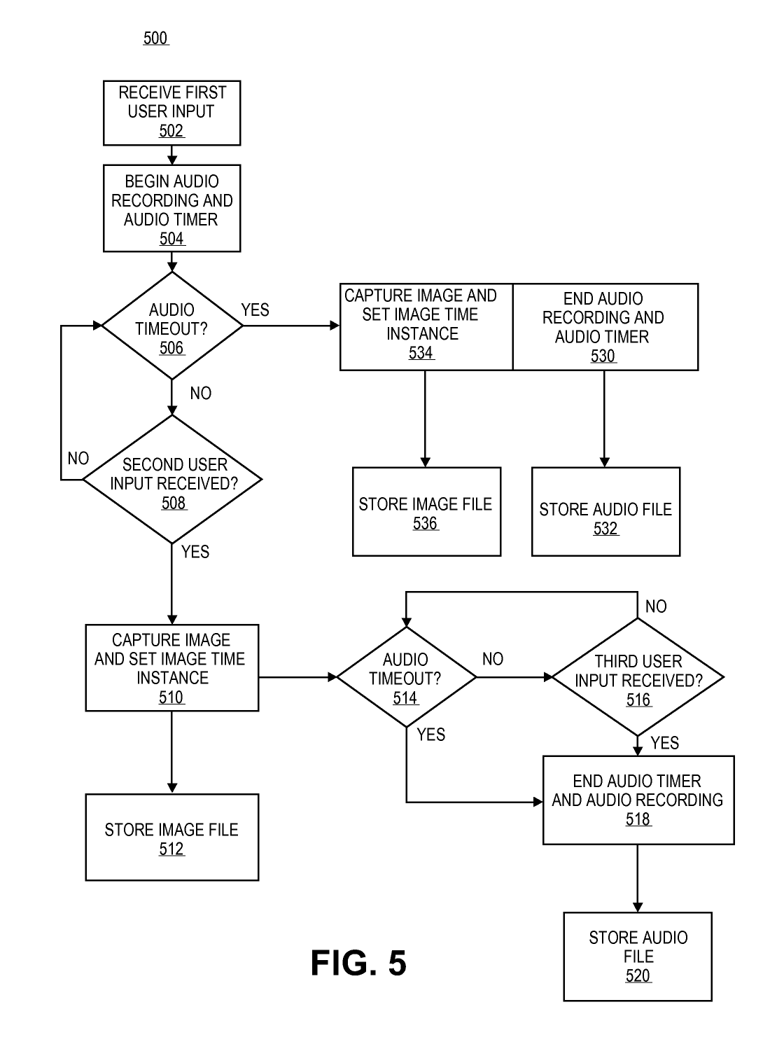

FIG. 5 illustrates a flowchart 500 of an embodiment of the invention. A first user input, such as but not limited to a button press, is received at step 502. Audio recording and a corresponding audio timer are then begun at step 504. So long as the audio timer does not time out at 506, and a second user input is not received at 508, the audio recording continues. So long as the audio timer does not time out at 506, if a second user input, such as but not limited to a button release, is received at 508, an image is then captured at step 5 10. In conjunction with the image being captured, an “image time instance,” or an instance in time at which the image is captured, may be set. The image, optionally along with the image time instance, may then be stored at step 512.

Also, so long as the audio timer does not time out at 514, and a third user input is not received at 516, the audio recording continues. Once either the audio timer times out or a third user input, such as but not limited to another button press, is received, the audio timer and recording are ended at 518. The recorded audio file is then stored at step 520.

If, on the other hand, the audio timer times out at 506 prior to the second user input being received, the audio timer and recording are ended at 530, simultaneously with the image being captured and, optionally, image time instance being set at 534. The recorded audio file and image file may then be stored at steps 532 and 536, respectively.

The image and/or audio file may be stored with metadata, such as but not limited to the time that the image/audio was captured, a name of the file, or other related data. The image file may later be displayed in relation with the audio file, and optionally with all or some of any stored metadata.

The determination of the point of image capture, or image time instance, as referred to above with regard to steps 510 and 534, is optional and not necessary to the invention. However, it may be beneficial to store this information so as to allow for later synchronization of the display of the image file with the image time instance, relative to the duration of the audio file during playback. The actual determination of the image time instance may be effected in various ways, for example, in relation to the duration of the audio recording, or instead in relation to absolute clock time. For example, the image time instance may be based on an offset value from the start of the audio timer. Alternatively, it may be based on the difference between an absolute time of the instance of image capture, and an absolute time of the start of the audio timer. Thus, if the audio timer began at 3:20:15.24 p.m., and the image was captured at 3:20:45.36 p.m., the image time instance would be determined to be 30.12 seconds after the beginning of the audio recording. In addition, the time points of 3:20:15.24 p.m. and 3:20:45.36 p.m. may also optionally be stored as metadata of potential interest.

During later playback of the audio file, the image may then be displayed at the corresponding image time instance. This function may be performed based on an offset timed from the beginning of the audio playback. Alternatively, metadata may be employed in the audio stream so as to trigger, at the corresponding image time instance, a signal to display the image. This latter method may in some cases render a more accurate timing of the image display, should the rate of audio playback not equal the rate of the earlier audio recording. In such a situation, if the image is displayed based on a timed offset, the image may be rendered off-sync with the intended instance of the audio. Using a trigger within the audio stream thus alleviates this problem.

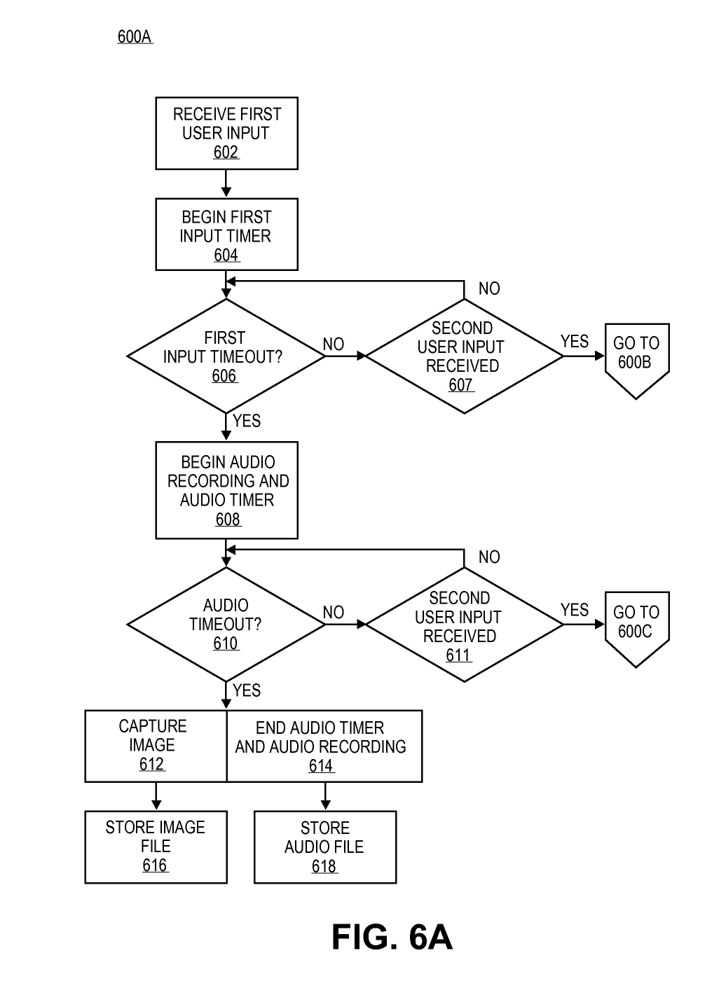

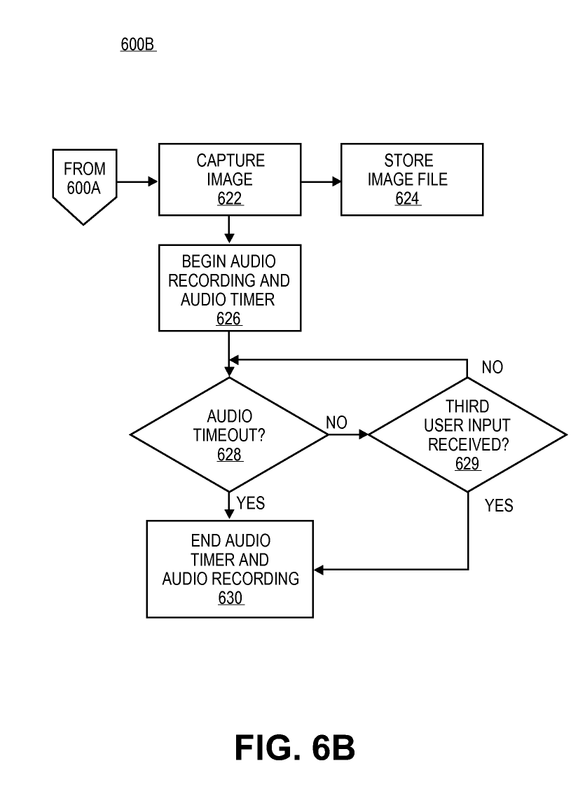

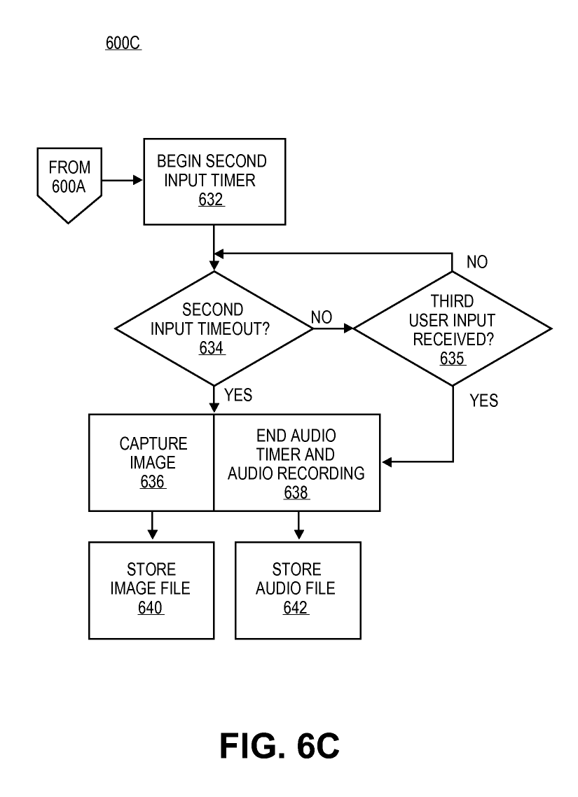

Another embodiment of the invention is illustrated in flowcharts 600A-C of FIGS. 6A-C. A first user input, such as but not limited to a button press, is received at step 602 as shown in flowchart 600A of FIG. 6A. A first input timer is then initiated at step 604. If the if the first input timer times out at 606 prior to a second user input, such as but not limited to a button release, being received at 607, then audio recording and a corresponding audio timer are begun at step 608. If the audio timer times out at 610 prior to a second user input begin received at 611, then an image is captured at 612, and the audio timer and audio recording are ended at 614. The recorded image file and audio file may then be stored at steps 616 and 618, respectively.

If, however, the audio timer does not time out at 610 prior to receiving a second user input at 611, then after receiving the second user input, a second input timer is initiated at step 632 as shown in flowchart 600 of FIG. 6C. If the second input timer times out at 634 prior to receiving a third user input, such as but not limited to another button press, at 635, then an image is captured at 636, and the audio timer and audio recording are ended at 638. The recorded image file and audio file may then be stored at steps 640 and 642, respectively. If instead a third user input is received at 635, an image is captured at 636, and the audio timer and audio recording are ended at 638, without awaiting the timeout of the second input timer.

If a second user input is received at 607, prior to the first input timer timing out at 606, then an image is captured at step 622, as shown in flowchart 600B of FIG. 6B. The image file may be stored in step 624. After the image is captured, audio recording and a corresponding audio timer may be initiated at step 626. If the audio timer times out prior to a third user input being received, then the audio timer and audio recording are ended at 630. If instead a third user input is received at 629, the audio timer and audio recording are ended at 630, without awaiting the timeout of the audio timer.

Thus, an embodiment of the invention provides a method that receives a user input. Then a recording of an audio file and a corresponding audio timer are initiated. When the audio timer times out, the recording of the audio file is ended, and an image file is captured. Although specific embodiments of the invention have been described and illustrated, the invention is not to be limited to the specific forms or arrangements of parts so described and illustrated. The scope of the invention is to be defined by the claims appended hereto and their equivalents.

1. A method, comprising:
receiving a first user input;
initiating a recording of an audio file and a corresponding audio timer; and
when the audio timer times out,
ending the recording of the audio file, and
capturing an image file.

2. A method, comprising:
receiving a first user input;
initiating a recording of an audio file and a corresponding audio timer; and
if the audio timer times out prior to receiving a second user input, then
ending the recording of the audio file, and
capturing an image file.

3. The method of claim 2, wherein the first user input includes a press of a button and the second user input includes a release of the button.

4. The method of claim 2, wherein the capturing of an image file is performed at the end of the recording of the audio file.

5. The method of claim 2, further comprising:
if the audio timer does not time out prior to receiving a second user input, then after receiving the second user input,
capturing an image file.

6. The method of claim 5, further comprising:
if the audio timer does not time out prior to receiving a third user input, then after receiving the third user input,
ending the recording of the audio file.

7. The method of claim 6, wherein the third user input includes a press of a button.

8. The method of claim 2, further comprising:
storing the audio file; and
storing the image file.

9. The method of claim 2, further comprising:
displaying the image file in relation with a playback of the audio file.

10. The method of claim 2, further comprising:
determining a time instance at which the image file is captured during the recording of the audio file; and
storing data, based on the time instance, in relation with one of the audio file and the image file.

11. The method of claim 10, wherein the determining the time instance includes registering the time at which the image file is captured, relative to the beginning of the recording of the audio file.

12. The method of claim 10, wherein determining the time instance includes calculating a difference between a first absolute time at which the recording of the audio file begins, and a second absolute time at which the image file is captured.

13. The method of claim 10, further comprising:
displaying the image file in synchronization with the time instance during a playback of the audio file.

14. The method of claim 13, wherein the displaying is based on a relative time offset, timed from the beginning of the playback.

15. The method of claim 13, wherein the displaying is based on a trigger in a stream of the audio file.

16. A method, comprising:
receiving a first user input;
initiating a first input timer; and
if the first input timer times out prior to receiving a second user input, then
initiating a recording of an audio file and a corresponding audio timer,
if the audio timer times out prior to receiving a second user input, then
ending the recording of the audio file, and
capturing an image file,
if the audio timer does not time out prior to receiving a second user input, then after receiving the second user input,
initiating a second input timer,
if the second input timer times out prior to receiving a third user input, then
ending the recording of the audio file, and
capturing an image file,
if the second input timer does not time out prior to receiving a third user input, then after receiving the third user input,
ending the recording of the audio file, and
capturing an image file.

17. The method of claim 16, further comprising:
if the first input timer does not time out prior to receiving a second user input, then after receiving the second user input,
capturing an image file,
initiating a recording of an audio file and a corresponding audio timer,
if the audio timer times out prior to receiving a third user input, then
ending the recording of the audio file, and
if the audio timer does not time out prior to receiving a third user input, then after receiving the third user input,
ending the recording of the audio file

18. The method of claim 16, wherein the first user input includes a press of a button, the second user input includes a release of the button, and the third user input includes another press of the button.

19. The method of claim 16, further comprising:
storing the audio file; and
storing the image file.

20. The method of claim 16, further comprising:
displaying the image file in relation with a playback of the audio file.

21. The method of claim 16, further comprising:
determining a time instance at which the image file is captured during the recording of the audio file; and
storing the time instance in relation with one of the audio file and the image file.

22. The method of claim 21, wherein determining the time instance includes calculating a difference between the time at which the second input timer is initiated, and a time at which the second input timer times out.

23. The method of claim 21, wherein determining the time instance includes calculating a difference between a first absolute time at which the recording of the audio file begins, and a second absolute time at which the image file is captured.

24. The method of claim 21, further comprising:
displaying the image file in synchronization with the time instance during a playback of the audio file.

25. The method of claim 24, wherein the displaying is based on a relative time offset, timed from the beginning of the playback.

26. The method of claim 24, wherein the displaying is based on a trigger in a stream of the audio file.
